(19) United States
(12) Patent Application Publication
(10) Pub. No.: US 2023/0318715 A1
(43) Pub. Date: Oct. 5, 2023

(54) ADAPTIVE HYBRID OPTICAL DETECTION

(71) Applicant: THE UNIVERSITY COURT OF THE UNIVERSITY OF EDINBURGH, Edinburgh (GB)

(72) Inventors: Majid SAFARI, Edinburgh (GB); Shenjie HUANG, Edinburgh (GB)

(21) Appl. No.: 18/020,895

(22) PCT Filed: Aug. 10, 2021
(86) PCT No.: PCT/EP2021/072234

§ 371 Date: Feb. 10, 2023

(30) Foreign Application Priority Data
Aug. 11, 2020 (GB) 2012496.2

(51) Int. Cl. H04B 10/67; H04B 10/112

(52) U.S. Cl. CPC H04B 10/67; H04B 10/112

(57) ABSTRACT

A receiving device (12) for receiving an optical communication signal, wherein the optical communication signal comprises an encoded or modulated signal, the device comprising: one or more photodetectors (12) configured to produce photodetector signals in response to detecting photons; one or more further photodetectors (14) configured to produce further photodetector signals; a controller (16) configured to select an operational mode of the receiving device in dependence on at least a light level, wherein the operational mode is one of at least a first mode in which a demodulation or decoding process is performed on the photodetector signals and a second mode in which the demodulation or decoding process is performed on the further photodetector signals, and a photon count limiter (18) associated with the one or more photodetector for controlled limiting of the photon count of the one or more photodetectors in dependence on at least a light level.

### FIELD

The present invention relates to a receiving device and a method for receiving an optical communication signal.

### BACKGROUND

In recent decades, as the scarcity in the radio frequency (RF) spectrum increasingly provides a bottleneck in the development of wireless communication networks, optical wireless communication (OWC) has attracted significant interest in both industry and scientific community due to its potential advantages that may include, for example, high data rate, and license-free spectrum. OWC covers a range of communication technologies over the broad spectrum of light including ultra-violet, visible and infra-red light and can be applied in both indoor and outdoor environments.

The outdoor OWC, commonly referred as free-space optical communication (FSO), is typically based narrow-beam coherent sources. The potential applications of FSO include but are not limited to inter-building communication and wireless backhaul solution of future 6G systems. However, before the wide-scale deployment and utilization of FSO systems, some major technical challenges remain to be overcome. For example, these problems may include turbulence-induced intensity fluctuation (also referred to as scintillation), misalignment loss induced by building sway, and link failure in the presence of adverse weather condition.

Both turbulence-induced fluctuation and misalignment have been thoroughly investigated in the literature. To mitigate the degradation of intensity fluctuation, numerous techniques are known, including, for example, spatial diversity and multi-hop relaying. To address misalignment loss, several beam-width optimization or adaptive tracking systems may be employed.

Separately from the above, the signal attenuations introduced by adverse weather conditions, for example, fog and haze, are substantially static in time and may be up to several hundred of dB/km. To increase the availability of FSO links during adverse weather conditions, so-called hybrid RF/FSO links have been proposed in which an additional RF link is employed to support the FSO link and maintain the connectivity.

To improve receiver sensitivity, a commonly used linear photodiode (LPD) may be biased above a breakdown voltage to be operated in Geiger mode as a single-photon counting avalanche diode (SPAD). Besides FSO systems, SPADs may also be used in other OWC systems, for example, visible light communication (VLC) and underwater optical communication. However, the achievable sensitivity of the current SPAD receivers is still limited by several non-ideal factors, including, for example, dead time, after-pulsing, fill factor and crosstalk.

A typical SPAD circuit may include a SPAD provided together with a quenching circuit. The quenching circuit may be considered as an avalanche recovery circuit. In use, a single photon arriving at the SPAD triggers an avalanche current i.e. current carries grow exponentially. The SPAD allows a current to be produced that can be measured from a single photon. However, due to the avalanche process there is an inactive period following the avalanche, during which the avalanche current is quenched (i.e. the SPAD recover and is again able to detect). During the inactive period or dead time, any photon reaching the SPAD is not detected. Saturation of a SPAD describes the process whereby the SPAD is saturated by photons. Saturation may be referred to as dead-time pile up.

There are two typical types of quenching circuits in SPAD receivers, i.e., active quenching (AQ) and passive quenching (PQ). The dead time of the former type of SPAD may be constant, whereas for the latter the photons arriving during the dead time may extend its duration.

Dead time pile up may significantly degrade the performance of a SPAD-based receiver. For example, if due to saturation, the SPAD receives photons at a rate such that a photon is received immediately following the SPAD recovery, the SPAD will be experiencing current nearly continuously, which is harmful to the SPAD. Degradation of the performance of a SPAD-based receiver may occur when the incident light intensity is relatively high because of non-linear distortion caused by SPAD saturation.

A problem with known OWC systems is that these systems may typically require a reliable and smooth operation over a very large dynamic range of incident light intensity. This may be an issue, for example, in optical wireless links such as in outdoor FSO communication links or indoor VLC networks where the optical receiver generally operates reliably using a conventional photodetector at high data rate but may experience occasional deep fades with very low signal levels. The low signal level may be due to, for example, adverse weather for FSO or blockage of a communication path or dimming for VLC, which may require optical receivers with very high sensitivity.

Combining the functionality of a conventional linear photodiode and a highly sensitive SPAD array in a hybrid receiver is known for imaging applications. For example, in Ouh et. al. “Combined in-pixel linear and single-photon avalanche diode operation with integrated biasing for wide-dynamic-range optical sensing,” IEEE Journal of Solid-State Circuits, vol. 55, no. 2, pp. 392-403, 2020, an array of 64 pixels is presented in which the linear and single-photon operations are combined at the pixel levels to improve a dynamic range. Each individual pixel can alternatively switch between these modes according to the applied voltage signal. However, the reported bandwidth and photon detection probability (PDP) may be quite low and the complex circuit design may also result in a low fill factor. As a result, such optical sensors may not be suitable for application to high-speed sensitive OWC systems.

Furthermore, SPAD array detectors and LPDs have significantly separated dynamic range of operations particularly in high-speed applications. The SPAD array receivers can provide high sensitivity to operate at low light levels but its detection response eventually saturates (and significantly degrades in practical passive quenching designs) due to dead time when the incident light intensity goes beyond a threshold, as described above.

FIG. 1 illustrates the gap between operational ranges of the SPAD array and the LPD array. FIG. 1 illustrates an example of the bit error rate (BER) for the SPAD array and LPD over various received signal power. The bit error rate of the individual detectors is described assuming on-off keying (OOK) modulation of the optical signal. The reliable operation ranges of communication system (with BER less than 10-3) clearly do not overlap for the two systems and there is an identified gap between the reliable ranges.

In addition to the above, a high light intensity may generate intersymbol interference (ISI) effect in SPADs induced by the dead time, which degrades the performance of a communication system further. On the other hand, in high-speed optical communications, the thermal noise in linear photodiodes becomes dominant and substantially degrades the performance of LPD at lower light levels, which greatly widens the gap between the operation regimes of the two receivers. This problem is particularly apparent in high-speed, communication applications while in low-speed scenarios (e.g., sensing applications), it is possible to reduce the thermal noise effect using large integration windows.

### SUMMARY

In accordance with a first aspect, there is provided a receiving device for receiving an optical communication signal, wherein the optical communication signal comprises an encoded or modulated signal, the device comprising: one or more photodetectors configured to produce photodetector signals in response to detecting photons; one or more further photodetectors configured to produce further photodetector signals; a controller configured to select an operational mode of the receiving device in dependence on at least a light level, wherein the operational mode is one of at least a first mode in which a demodulation or decoding process is performed on at least the photodetector signals and a second mode in which the demodulation or decoding process is performed on at least the further photodetector signals, and a photon count limiter associated with the one or more photodetectors for controlled limiting of the photon count of the one or more photodetectors in dependence on at least a light level.

In the first mode, a demodulation or decoding process is performed on the photodetector signals and in the second mode, the demodulation or decoding process is performed on at least the further photodetector signals

The one or more photodetector may comprise one or more photon-counter photodetectors or one or more photon-counting photodetectors. The one or more photodetectors may be configured to perform a photon counting process and/or count photons and/or operate in a photon-counting mode.

The device may comprise demodulation or decoding circuitry configured to perform a demodulation or decoding process on the photodetector signals and the further photodetector signals in accordance with a pre-determined modulation or coding scheme thereby to extract data.

The device may comprise an output interface for providing the photodetector signals to a further device that comprises demodulation or decoding circuitry.

The one or more photodetectors may comprise one or more single-photon counting photodetectors. The one or more single-photon counting photodetectors may be configured to count single-photons. The one or more photodetectors may comprise one or more SPADs. The one or more photodetectors may comprise one or more photodetector arrays. The one or more photodetectors may comprise a single photodetector. The one or more further photodetectors may comprise a single further photodetector. The one or more photodetectors and/or further photodetectors may comprise one or more photodetector or further photodetector devices.

The one or more further photodetectors may comprise one or more linear photodetectors. The one or more photodetectors may comprise one or more single-photon avalanche diodes (SPADs).

The one or more photodetectors may comprise one or more photodetectors having one or more physical characteristics affecting performance, for example, an intrinsic dead time. The one or more photodetectors may comprise active or passive quenching circuits. The one or more photodetectors may comprise a photodetector configured to operate in Geiger mode or a suitable photon-counting mode.

The device may comprise at least one of switching device and/or a switching apparatus and/or switching circuitry and/or one or more switching components. The photon count limiter may comprise at least one of a photon detection-limiting device and/or photon detection circuitry and/or one or more photon detection limiting components. The controller may comprise processing circuitry. The device may further comprise a memory resource.

The controller may be configured to control the operational mode of the device and/or to control the photon count limiter to target at least one of: a maximum value of a measure of signal quality and/or signal strength and/or achievable data rate and/or a minimum measure of error rate.

The controller may be configured to control the operational mode and/or the photon detection limit by sending one or more control signals.

The photon count limiter may be controllable to limit the photon count of the one or more photodetectors below a variable upper threshold value. By limiting the photon count, the strong non-linear distortion introduced by high photon rates may be avoided and hence the one or more photodetectors performance may be maintained.

Control of the photon detection limiter to limit the number of photodetector events detected by the one or more photodetectors may comprise selecting or adjusting a value for a control parameter for the photon detection limiter.

The photon count limiter may comprise a variable optical attenuation device arranged to attenuate light for the one or more photodetectors, wherein the degree of attenuation of light is controlled by selecting and/or adjusting a control parameter of the variable optical attenuation device.

The photon count limiter may comprise time gating circuitry associated with the one or more photodetectors configured to perform a gating process thereby to limit the number of photodetector signals produced by the one or more photodetectors.

The time gating process may be characterized by a time window such that at least one of a) and b):
a) photodetector signals are produced only in response to photons incident on the one or more photodetectors during the time window;
b) the one or more photodetectors are activated during the time window and deactivated otherwise.

The time gating process may be such that the number of photons counted by each SPAD in the time window is lower than an upper limit which is in dependence on the time window.

The controller may be configured to adjust or select a control parameter of the time gating circuitry thereby to change the size of the time window in response to at least a change in the light level.

The gating circuitry may be configured to perform a gating process such that the number of photons counted during the time window is fewer than the number of detectable photons incident on the one or more photodetectors during a symbol duration.

The signal may comprise data modulated and/or encoded in accordance with a modulation rate such that modulated and/or encoded data comprises a symbol duration. The time window may comprise a time duration smaller than the symbol duration. The gating circuitry may be configured to perform a gating process such that, the number of photons counted during the time window is fewer than the number of detectable photons incident on the one or more photodetectors during a symbol duration. The gating process may be such that the number of photons counted during the symbol duration is fewer than the number of photons incident

The gating process may be applied based on the symbol duration. The gating process may be synchronised with the symbol duration such that a single time window is applied for each symbol duration. A detectable photon may be any photon incident on the one or more photodetectors during an active state. A detectable photon may be any photon incident on the one or more photodetectors not during an inactive or dead time. The number of dead time events and/or frequency of dead time events may be reduced by the time gating process.

The device may comprise at least one controllable switching component controllable by the controller, the at least one controllable switching component being controllable to be in at least one of a first configuration and a second configuration, such that the controller places the at least one controllable switching component in the first configuration when the device is in the first mode and in the second configuration when the device is in the second mode.

In the first configuration, the controllable switching component allows photodetector signals from the one or more photodetectors to be provided to the demodulation/decoding circuitry. In the second configuration, the controllable switching component allows photodetector signals from the further photodetectors to be provided to the demodulation/decoding circuitry.

Selecting the operational mode of the device to be the first mode may comprise controlling the at least one controllable switching component to be in the first configuration. Selecting the operational mode to be in the second mode may comprise controlling the at least one controllable switching component to be in the second configuration.

The at least one controllable switching component may comprise an optical switching apparatus, wherein light is incident on the optical switching apparatus and, in the first configuration, the optical switching apparatus provides at least part of the received light to the one or more photodetectors and, in the second configuration, the optical switching apparatus provides at least part of the received light is provided to the one or more further photodetectors.

The optical switching component may comprise one or more optical switching components configured to re-direct, permit transmission and/or prevent transmission of received light thereby to change an optical path of the received light.

The photon count limiter may form part of the optical switching apparatus such that the optical switching apparatus is controllable to receive light and to direct a controlled portion of received light to either the photodetectors or the further photodetectors in dependence on a control parameter.

The at least one controllable switching component may comprise signal routing circuitry such that, in the first configuration, the signal routing circuitry routes signals from the one or more photodetectors for the demodulation or decoding process and, in the second configuration, the signal routing circuitry routes signals from the one or more further photodetectors for the demodulation or decoding process.

In the first configuration, the signal routing circuitry may route signals from the one or more photodetectors to demodulation or decoding circuitry and, in the second configuration, the signal routing circuitry may route signals from the one or more further photodetectors to demodulation or decoding circuitry.

In the first configuration, the signal routing circuitry may route signals from the one or more photodetectors to an output interface of the device to be transmitted to a remote device comprising demodulation or decoding circuitry and, in the second configuration, the signal routing circuitry may route signals to an output interface of the device to be transmitted to a remote device comprising demodulation or decoding circuitry. The controller may comprise said signal routing circuitry.

The at least one controllable switching component comprises at least one electromechanical component that is moveable or orientable via an electronic control signal provided by the controller.

The device may further comprise one or more optical steering components for steering received light to the one or more photodetectors and/or the one or more further photodetectors. The one or more steering components may comprise at least one of: an optical splitter, a lens, an aperture, an optical microelectromechanical system (MEMS). The photon count limiter may comprise at least one electromechanical component that is moveable or orientable via an electronic control signal provided by the controller.

The controller may comprise processing circuitry configured to obtain a value for a control parameter for the controllable photon limiter based on a pre-determined relationship between the control parameter and at least the light level, wherein the pre-determined relationship is in dependence on a modulation or coding scheme.

The device may further comprise a memory resource for storing a mapping between a plurality of values of the control parameter and a plurality of ranges of light level, and wherein obtaining the value for the control parameter comprises retrieving a stored value from the memory resource using the light level and the mapping.

The controller may be further configured to perform a comparison process between a first measure representative of achievable signal quality and/or signal strength and/or data rate and/or bit error rate from the one or more photodetectors for the light level and a second measure representative of signal quality and/or signal strength and/or data rate detected via the further photodetectors for the light level and further configured to select the operational mode and/or the photon detection limiter based on said comparison process.

The controller may be configured to route signals either from the one or more photodetectors or from the one or more further photodetectors to demodulation or decoding circuitry or an output interface of the device. The device may further comprise monitoring circuitry configured to monitor output from the one or more photodetectors and output from the one or more further photodetectors to determine at least one of a change in light level, a measure of signal quality or strength.

The modulation and/or coding scheme may comprise an intensity modulation scheme, for example, an on-off keying based modulation scheme, an optical OFDM based scheme, PAM or PPM.

The controller may be further configured to place the one or more further photodetectors to a lower power mode when the device is switched to the first mode and to place the one or more photodetectors to a lower power mode when the device is switched to the second mode.

The device may further comprise light level detection circuitry configured to receive output from at least one of the one or more photodetectors and the one or more further photodetectors and determine the light level using the received output of the one or more photodetectors and/or the one or more further photodetectors. The light level detection circuitry may comprise a dedicated light level detection component.

The light level detection circuitry may be configured to provide a signal to the controller. The light level detection may be configured to process the received output to determine a change in light level. The controller may be configured to determine a change in light level. The light level may comprise a background light level and a signal light level.

The one or more photodetectors and the one or more further photodetectors may comprise at least one common photodetector. The at least one common photodetector may be operable in a first mode in which the at least one common photodetector produces the photodetector signals and a second mode in which the at least one common photodetector produces the further photodetector signals. The controller may be configured to change the operational mode of the at least one common photodetector based on at least the light level.

The one or more photodetectors and the one or more further photodetectors may comprise at least one common component.

In accordance with a second aspect, there is provided a method of receiving an optical communication signal using a receiving device operable in at least a first or second mode, the method comprising:
selecting an operational mode for the receiving device based on at least a light level, and in response to selecting the first mode:
   receiving light at one or more photodetectors and producing photodetector signals;
   limiting the received photon count of the one or more photodetectors in dependence on the light level; and
   performing a demodulating or decoding process on the photodetector signals in accordance with a pre-determined modulation or coding scheme thereby to extract data; and
in response to selecting the second mode:
   receiving light at one or more further photodetectors and producing further photodetector signals and performing demodulation or decoding process on the further photodetector signals in accordance with the pre-determined modulation or coding scheme thereby to extract data.

In accordance with a third aspect, there is provided a non-transitory computer readable medium comprising instructions operable by a processor to perform the method of the second aspect.

In accordance with a further aspect, there is provided a receiving device for receiving an optical communication signal, wherein the optical communication signal comprises an encoded or modulated signal, the device comprising: one or more photodetectors operable in at least a first mode or a second mode, wherein in the first mode, the one or more photodetectors are configured to produce photodetector signals in response to detecting photons and wherein in the second mode the one or more photodetectors are configured to produce further photodetector signals. The device further comprises: a controller configured to select an operational mode of the one or more photodetectors and an operational mode of the receiving device in dependence on at least a light level, wherein the operational mode of the receiving device is one of at least a first mode in which a demodulation or decoding process is performed on the photodetector signals and a second mode in which the demodulation or decoding process is performed on the further photodetector signals. The receiving device further comprises a photon count limiter associated with the one or more photodetector for controlled limiting of the photon count of the one or more photodetectors in dependence on at least a light level. The first operational mode of the one or more photodetectors may be a non-linear or SPAD mode. The second operational mode of the one or more photodetectors may be a linear photodetector mode.

Features in one aspect may be applied as features in any other aspect, in any appropriate combination. For example, device features may be provided as method features or vice versa.

### BRIEF DESCRIPTION OF THE DRAWINGS

Various aspects of the invention will now be described by way of example only, and with reference to the accompanying drawings, of which:

FIG. 2 is a schematic diagram showing, in overview, a receiving device in accordance with embodiments;

FIG. 3 is a schematic diagram showing a receiving device, in accordance with a further embodiment;

FIG. 4 is a schematic diagram showing a receiving device, in accordance with a further embodiment;

FIG. 5 is a circuit-timing diagram illustrating operation of time gating circuitry;

FIG. 6 depicts a flowchart illustrating an example of a control algorithm for the receiving device, in accordance with embodiments;

FIGS. 7(a) to 7(d) depict graphs of results achieved using the receiving device;

FIGS. 8(a) to 8(d) depict graphs of the variation of the optimal operational parameters of a photon count limiter over received signal power;

FIG. 9 is a schematic diagram of a receiving device together with a transmitting device, in accordance with embodiments;

FIG. 10 is a photograph of the receiving device, in accordance with embodiments, and

FIG. 11 depict graphs of experimental results achieved using the receiving device of FIG. 10

### DETAILED DESCRIPTION

In the following, the term optical communication is used. It will be understood that this may cover different forms of optical communication in which data is encoded or modulated onto light or other form of electromagnetic radiation. The term light used herein may be used, for example, to refer to electromagnetic waves with wavelengths in the range 1 nm to 1 mm, which include, for example, ultraviolet, visible light, near-infrared and infrared wavelengths.

The embodiments described in the following, relate to an adaptive hybrid receiver that can switch between a single or an array of SPADs (or a suitable alternative photon-counter photodiodes) and linear photodiodes. The hybrid receiver has additional elements, including a photon count limiter for extending the operational range of the receiver to bridge the gap between operational range of the SPAD and linear photodiodes.

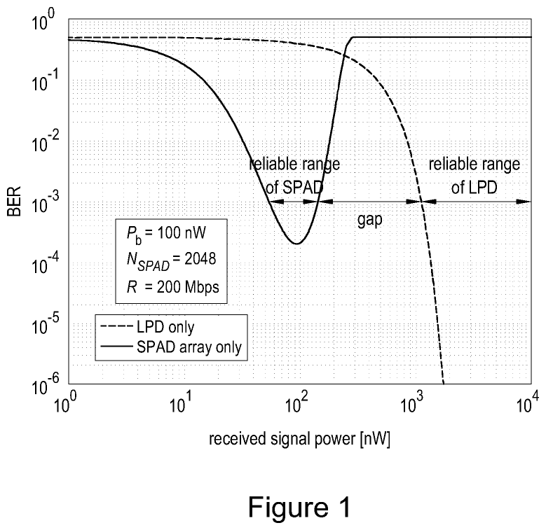

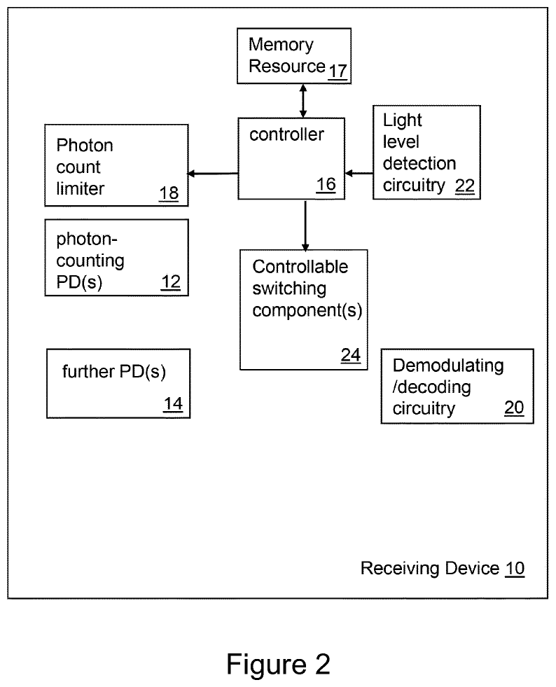

FIG. 2 is a schematic diagram depicting a high-level overview of a receiving device for receiving an optical communication signal. The receiving device 10 has one or more photon-counter photodetectors 12 (for brevity referred to as the photon-counter photodetectors 12) and one or more further photodetectors 14 (for brevity referred to as the further photodetectors). Although FIG. 2 depicts a plurality of photon-counter photodetectors and a plurality of further photodetectors, it will be understood that in some embodiments, only a single photon-counter photodetector and/or a single further photodetector is provided. The photon-counter photodetectors are configured to count photons and may also be referred to as photon-counting photodetectors.

The receiving device 10 has a controller 16, which, in some embodiments comprises controlling circuitry and/or processing circuitry. The controller 16 is configured to perform a control process for operating the device 10. The device 10 further has a photon count limiter 18 provided in association with the photon-counter photodetectors 12.

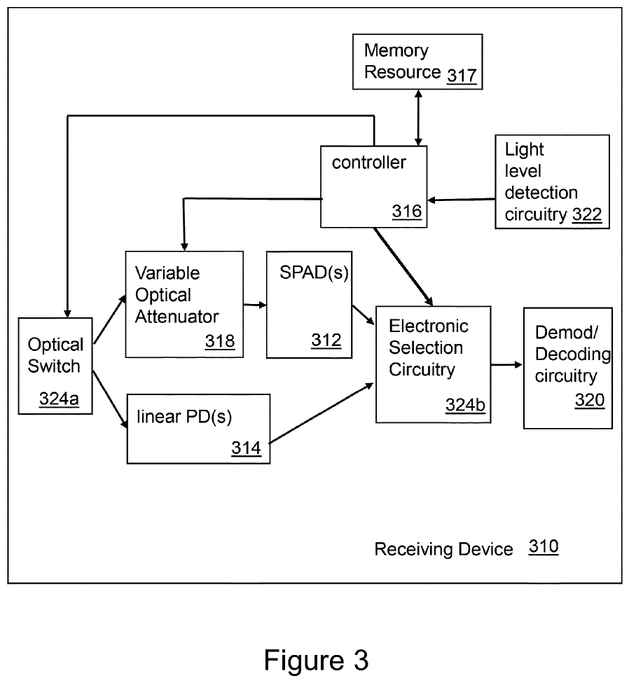

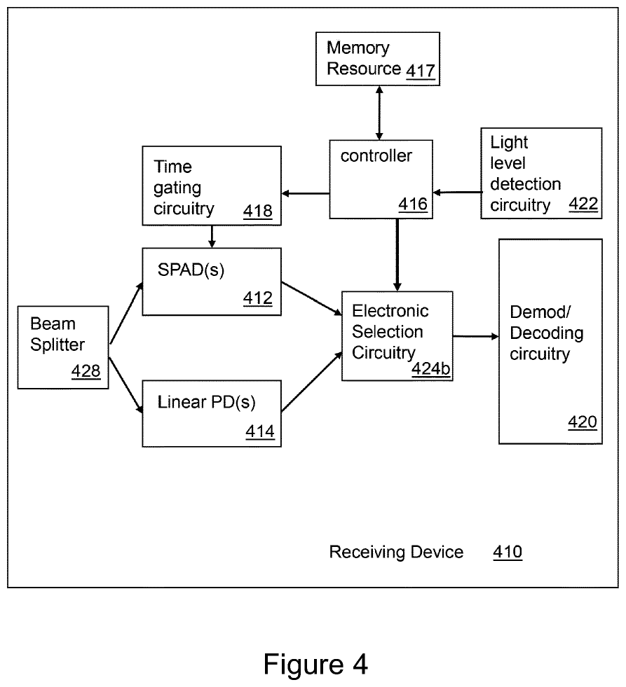

While FIG. 2 depicts a high-level overview of the receiving device 10, a first example embodiment is described in further detail with reference to FIG. 3 and a second example embodiment is described in further detail with reference to FIG. 4

For the purpose of the following description, FIG. 2 shows a receiving device 10 having demodulation/decoding circuitry 20 for performing a demodulation/decoding process on photodetector signals detected by the photon-counter photodetectors 12 and the one or more further photodetectors 14. While FIG. 2 shows the demodulation/decoding circuitry provided as part of the receiving device 10, it will be understood that, in other embodiments, the demodulation/decoding circuitry is provided as part of a further device. In such embodiments, an output interface is provided for interfacing with the further device to provide the photodetector signals to the demodulation/decoding circuitry of the further device.

In the following embodiments, the photon-counter photodetectors 12 are SPADs and the further photodetectors are linear photodetectors. A SPAD has an intrinsic dead time following a detecting of a single photon. During dead time, a SPAD is unable to detect a photon. The SPADs are provided together with quenching circuits.

The receiving device 10 further comprises light level detection circuitry 22. In the present embodiment, the light level detection circuitry 22 is provided in association with the photon-counter photodetectors 12 and the further photodetectors 14 and is configured to receive an output from at least one of the photon-counter photodetectors 12 and the further photodetectors 14 and determine a light level using that output. The output that is received could be at least part of the photodetector signals themselves or at least part of the photodetector signals.

The light level detection circuitry 22 provides a signal to the controller 16 representative of the detected light level. The controller 16 is configured to control one or more components of the device to select an operational mode of the device in dependence on at least the light level. In some embodiments, the receiving device has a memory resource 17 for storing instructions for the controller 16 to perform a control method or to store values of control parameters or other parameters required for the control method or previously determined light levels.

In low-level lighting conditions, the receiving device 10 operates in a first mode in which photo-detection is performed substantially by the photon-counter photodetectors 12 and the photodetector signals from the photon-counter photodetectors 12 are demodulated/decoded to extract data from the optical communication signal. In higher-level lighting conditions, the receiving device 10 operates in a second mode in which photo-detection is performed substantially by the further photodetectors and the photodetector signals from the further photodetectors are demodulated/decoded. In this way, the receiving device 10 is configured to operate in dependence on lighting conditions and adapt to any changes in lighting conditions.

While the light level detection circuitry 22 has been described as operating together with the photodetectors, it will be understood that, in some embodiments, the light level detection circuitry may operate together or form part of another component of the receiving device 10 or the light level detection circuitry is provided as part of another component. As a non-limiting example, the light level may be determined by the demodulation/decoding circuitry. As a further non-limiting example, the light level detection circuitry is not provided as part of the receiving device 10 but instead provided as part of a further device in communication with the receiving device. In some embodiments, the light level is determined by a separately provided monitoring device. In some embodiments, the light level may be determined by processing the photodetector signals from either the one or more photon-counter photodetectors or the one or more further photodetectors.

As depicted in FIG. 2, the photon-counter photodetectors 12 are provided together with a photon count limiter 18, which is configured to limit the number of photon detection events detected or counted by the photon-counter photodetectors 12. The controller 16 is configured to control the photon count limiter 18 using one or more control signals. The limit on photon count is set by a value of a control parameter of the photon count limiter 18.

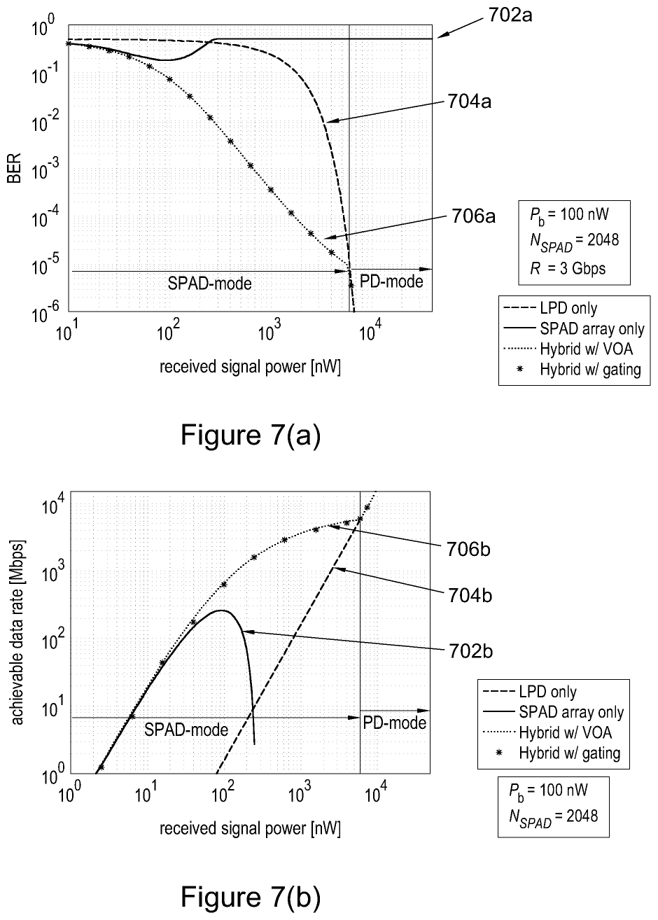

By adjusting the control parameter of the photon count limiter in real time and in response to changes in light conditions, the photon count limiter 18 allows the gap between the operational regimes of the photon-counter photodetectors 12 and the further photodetectors 14 to be bridged. In this gap, the light intensity is still too low for the further photodetectors 14 to give the highest efficiency, while the photon-counter photodetectors 12 is already saturated. In this regime, the receiving device 10 switches to the photon-counter photodetectors 12 while the photon count limiter 18 adaptively adjusts the number of photons counted by the photon-counter photodetectors to a level that allows optimal operation. The gap is depicted in, for example, in FIG. 7(b), wherein OOK modulation of the optical signal is assumed and the photon-counter photodetectors are an array of SPADs and the further photo-detector is a single linear photodetectors.

In some embodiments, the photon count limiter 18 limits the photon count via optical means. In such embodiments, the photon count limiter 18 physically restricts the amount of light that is incident on the photon-counter photodetectors 12. This limitation is by attenuation (a variable optical attenuator) or other suitable optical means. Such embodiments are described in further detail with reference to FIG. 3.

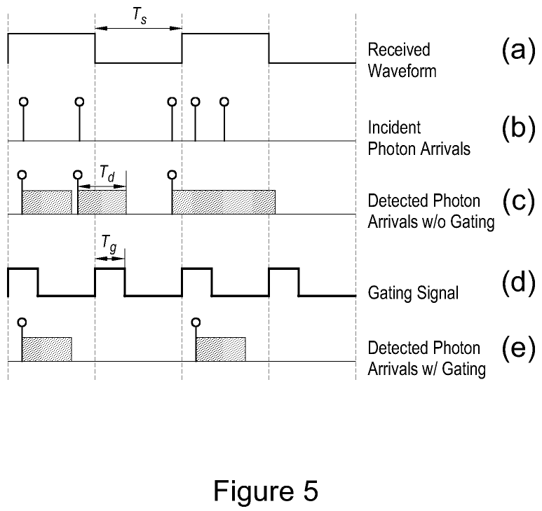

In other embodiments, the photon count limiter 18 limits the photon count via electronic/signal processing means. In such embodiments, time-gating circuitry is provided which moves the photon-counter photodetectors between an active state and a deactivated state such that the photon-counter photodetector can only detect photons in the activated state thereby limiting the number of photon detection events detected or counted. This essentially limits the length or amount of dead time the SPADs experience. In particular, the number of dead time events may be reduced. Such embodiments are described in further detail with reference to FIG. 4. The time gating process is described with reference to FIG. 5.

As mentioned above, the controller 16 is configured to select an operational mode of the receiving device 10 in dependence on a light level to switch between a first mode in which data from the communication signal is detected and decoded/demodulated using the photon-counter photodetectors 12 and a second mode in which the signal is detected and decoded/demodulated using the further photodetectors 14.

The controllable switching components 24 controlled by the controller 16 may comprise a controllable optical switch and/or electronic selection circuitry. In some embodiments, as part of the selecting an operational mode, the controller 16 is configured to control the controllable switching components 24 to be in a first configuration when the device is in a first mode or a second configuration when the device is in a second mode. It will be understood that, in some embodiments, only one of the controllable switching components is provided. For example, in some embodiments, no optical switch is provided as described with reference to FIG. 4.

In some embodiments, the controllable switching components 24 includes an optical switching apparatus, which, in the first configuration, directs light to the one or more photon-counter photodetectors and in the second configuration, directs light to the one or more further photodetectors. Embodiments with an optical switching apparatus, in particular, an optical switch, are described in further detail with reference to FIG. 3.

In some embodiments, the controllable switching components 24 includes controllable electronic signal switching circuitry, which may also be referred to as routing circuitry, for switching the route of the photodetector signals from the photon-counter photodetectors to the demodulation/decoding circuitry, in the first configuration, and from the further photodetector in the second configuration. Embodiments with controllable electronic signal switching circuitry are described in further detail with reference to FIG. 3 and FIG. 4.

In embodiments, in which the demodulation/decoding circuitry is provided as part of a remote device, the electronic signal selection circuitry selects a signal to be provided to output interface of the receiving device 10 for outputting to the remote device. In some embodiments, the electronic signal routing circuitry may be provided as part of the circuitry of the controller or the demodulation circuitry.

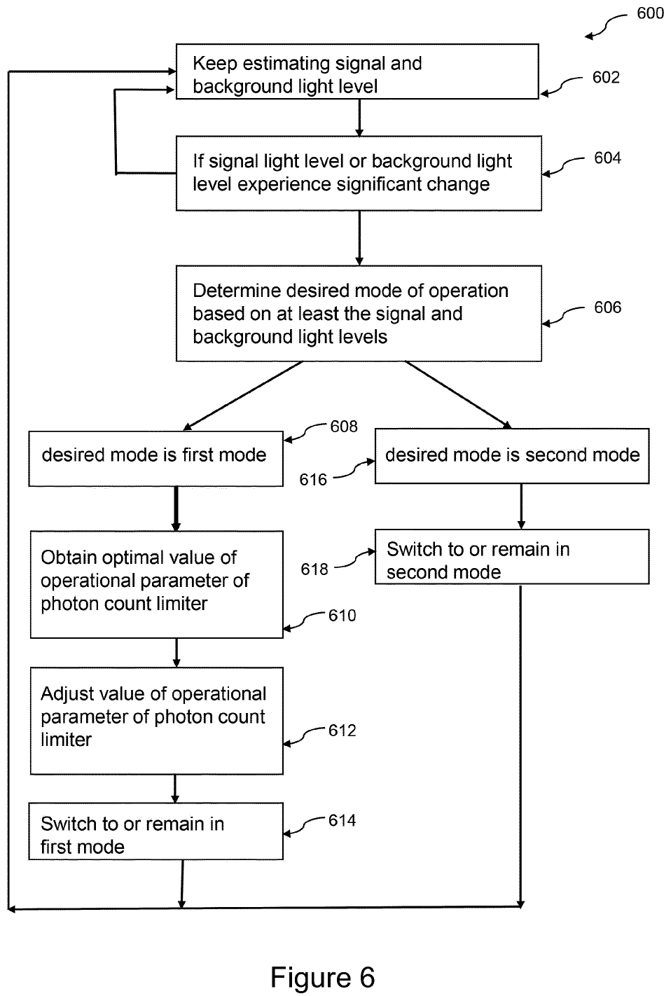

In the following, a description of operation of the receiving device is provided. It will be understood that while the controller 16 may control one or more components in dependence of at least a detected light level, the controller 16 may be further configured to perform more complex control processes based on other factors. A more detailed description of a control algorithm implemented in an embodiment, is described with reference to FIG. 6.

In use, the light level detection circuitry 22 detects a light level and transmits a signal representative of the light level to the controller 16. Based on at least the detected light level the controller 16 then determines a desired mode of operation of the device and selects or switches a mode of operation of the device. If the detected light level satisfies a particular condition, for example, if the light level is below a certain threshold, the controller 16 selects the first mode of operation. In the present embodiment, selecting the first mode of operation corresponds to the controller 16 controlling the controllable switching components to be in the first configuration. If the detected light level does not meet a particular condition, for example, the detected level is below a certain threshold, the controller 16 selects the second mode of operation. Selecting the second mode of operation corresponds to controlling the controllable switching components 24 to be in the second configuration.

When in the first mode, the controller 16 also controls the photon count limiter 18 to limit the photon count by adjusting or selecting a value for the control parameter for the photon count limiter 18. Further details of how the control parameter is selected or adjusted based on at least the detected level of light is provided with reference to FIG. 6.

When in the first mode of operation, light is received by the photon-counter photodetectors 12, which then in turn produce photodetector signals. However, the number of photons detected in the first mode is limited by the photon count limiter 18 and, in particular, by the value of the control parameter. In the first mode, the photodetector signals produced by the photon-counter photodetectors are provided to the demodulation and/or decoding circuitry 20 and a decoding/demodulating process is performed by the demodulation and/or decoding circuitry 20.

When in the second mode of operation, light is received by the further photodetectors 14, which in turn produce photodetector signals. In the second mode, the photodetector signals produced by the further photodetectors 14 are provided to the demodulation and/or decoding circuitry 20 and the decoding/demodulating process is performed.

The receiving device 10 is adaptive to changes in light level such that the receiving switches between the first mode and second mode in response to changes in light level. By adapting the operational mode in response to changes in light level together with active control of the photon count via the photon count limiter 18 when in low light conditions, the optical communication receiver maintains consistent performance in a number of different conditions and in changing environmental conditions.

FIG. 3 is a schematic diagram of a receiving device in accordance with a first embodiment and FIG. 4 is a schematic diagram of a receiving device in accordance with a second embodiment. As FIG. 3 realizes the photon count limiter optically the embodiment of FIG. 3 is herein referred to, for brevity, as the optical embodiment. As FIG. 4 realizes the photon count limiter electronically, the embodiment of FIG. 4 is herein referred to, for brevity, as the electronic embodiment.

Turning to the optical embodiment, FIG. 3 depicts a receiving device 310 having a SPAD array 312 and a linear photodetector array 314 corresponding to the photon-counters photodetectors 12 and further photodetectors 14, respectively, as described with reference to FIG. 2. The receiving device also has a controller 316, memory resource 317, demodulation circuitry 320 and light level detection circuitry 322, substantially corresponding to the controller 16, memory resource 17, demodulation/decoding circuitry 20 and the light level detection circuitry 22, as described with reference to FIG. 2. Receiving device 310 has a variable optical attenuator 318 corresponding to the photon count limiter 18 of FIG. 2 and an optical switch 324a and electronic selection circuitry 324b corresponding to the controllable switching components 24 of FIG. 2.

The optical switch 324a is a binary optical switch, and in the present embodiment, is a Micro-Electro-Mechanical Systems (MEMS) based component. The optical switch 324a can be switched (by controller 316) between a first configuration in which received light is directed in a first direction (towards the SPAD array 312) and a second configuration in which received light is directed in a second direction (toward the linear PD array 314).

As can be seen in FIG. 3, in the second configuration, the switched light passes directly to the linear PD array 314 from the optical switch 324a. However, in the first configuration, the light is directed to be incident on the variable optical attenuator 318 before illuminating the SPADs. The variable optical attenuator 318 attenuates the incident light to a degree determined by the value of the control parameter set by the controller 316 (the transmittance). The attenuated light then reaches the SPAD array 312 for photon detection. The output of the two detectors are then directed to electronic selection circuitry 324b which is controlled by the controller 316 to select one of the two signals to be demodulated by the demodulation circuitry 320. Electronic selection circuitry 324b may also be referred to as signal routing circuitry and may be provided as part of the controller 316.

By using a variable optical attenuator 318, the intensity of light can be controlled to an optimal level for the operation of the SPAD array 312 and to avoid saturation of the SPADs. In FIG. 3, the variable optical attenuator 318 is described as a separate component to the optical switch, but in other embodiments, is provides as part of a single optical apparatus.

In a further embodiment, the variable optical attenuator can be also embedded into the optical switch. For example, a MEMS based switch with variable tilting angle can be used to do both switching and variable attenuation functionalities. Alternatively, a MEMS array device can be used to act as a binary optical switch while directing an arbitrary proportion of the light towards the two detectors. In some embodiments, the MEMS array device may have a plurality of controllable mirrors, the mirrors being adjustable via control signals to vary their tilting angle.

Turning to the electronic embodiment, FIG. 4 depicts a receiving device 410 having a SPAD array 412 and a linear PD array 414 corresponding to the photon-counters photodetectors 12 and further photodetectors 14 described with reference to FIG. 2. The receiving device also has a controller 416, memory resource 417, demodulation circuitry 420 and light level detection circuitry 422, substantially corresponding to the controller 16, memory resource 17, demodulation/decoding circuitry 20 and the light level detection circuitry 22, as described with reference to FIG. 2. In contrast to the embodiment of FIG. 3, receiving device 410 has time gating circuitry 418 corresponding to the photon count limiter 18 of FIG. 2. Receiving device 410 also has further has electronic selection circuitry 424b corresponding to the electronic selection circuitry 324b of FIG. 3.

In place of the optical switch of receiving device 310, receiving device 410 has a beam splitter 428 for splitting an incoming beam and directing a portion of the beam towards the SPAD array 412 and a portion towards the linear PD array 414. In the present embodiment, an equal portion is provided to the SPADs and to the linear PDs. While the beam splitter splits the beam in a 50:50 splitting ratio in the present embodiment, it will be understood that in other embodiments, the ratio may not be 50:50 but may provide another fixed portion to each of the SPADs and linear PDs.

The use of a fixed beam splitter 428, instead of an optical switch, as described with reference to FIG. 3, may lead to a reduction in the sensitivity level of the receiver but may also simplify the hybrid design, as no control signal is required for splitting the power between the two detectors. Note that this fixed power splitting can be also realized based on an embedded design in which both the SPAD array and the linear photodiode are implemented on the same chip and are illuminated at the same time. Such an embodiment would eliminate the need for an optical power splitting element altogether.

In the receiving device 410, the photon count limiter is implemented in the electrical domain as time gating circuitry 418. The time gating circuitry 418 limits the time window during which a SPAD array is enabled to detect and respond to incident photons. The time gating circuitry is defined by a control parameter, in this case the size of the time window, T_{g}, which is also referred to as the gate-ON time interval.

In the time gating circuitry, an electrical gating signal, comprising a sequence of short pulses, is generated as a windowing function applied to the received modulated signal, for example, a pulse-based signal or a waveform like orthogonal frequency division multiplexing (OFDM) signal.

The application of the gate signal limits the number of photons that are counted (leading to the reduction of frequency of dead time occurrence) in each symbol period of the received modulated signal. Therefore, by adaptively adjusting the gate-ON time interval (T_{g}) which adjusts the photon count as a function of the incident intensity level, the timing circuitry allows the SPAD array to avoid saturation. Although shown in FIG. 4, as a separate component, it will be understood that, in some embodiments, the time gating circuitry is integrated into the SPAD array which may lead to a more compact design.

FIG. 5 provides a more detailed illustration of operation of the time gating circuitry and the dependence on the time gating parameter. FIG. 5 is a timing diagram for the time gating circuitry and a SPAD, in which time passes from left to right of the diagram. FIG. 5(a) shows a received waveform with OOK modulation with Tₛ refers to the symbol duration period. Using time gating, for each symbol duration the SPAD can only detect photons during the gate-ON time T_{g}. For simplicity, it is assumed that the transition time between gate states is negligible.

FIG. 5(b) shows five incident photon arrivals at the SPAD. FIG. 5(c) shows the photons that are detected without gating. In this case, the first, second and third photons are detected by the SPAD as they are separated in time by a period greater than the dead time T_{d} of the SPAD. However, the fourth and fifth photons are not detected, as these are incident during dead time of the SPAD. In particular, the fourth incident photon extends the dead time of the SPAD such that the fifth photon is not detected during the extended dead time.

FIG. 5(d) show a gating signal characterised by T_{g}. The gating signal turns the SPAD to an active state for the time T_{g}. The gating signal is applied with a frequency equal to the frequency of the symbol duration. In further detail, after every Tₛ period, the SPAD is active for a period of T_{g}. As T_{g}<Tₛ, for the remainder of the Tₛ period the SPAD is deactivated (i.e. for the deactivated time equal to Tₛ−T_{g}). The deactivated time period is also referred to as the gate OFF time. The SPAD is blind to incident photons during the gate-OFF time.

The symbol time, Ts, depends on the data rate which is typically above tens of Mbps for high speed communication applications. The dead time Td will depend on the specific photo-counter photodetector or SPAD used in the system. Typically, the dead time may be in the range of 1 ns to 1000 ns, or from several ns to hundreds of ns.

FIG. 5(d) shows a first, second, third and fourth time window, each having a size equal to T_{g}, and the SPAD is active during the first, second, third and fourth time window. FIG. 5(e) depicts which photons are detected with time gating switch on. In FIG. 5(e), the first and fourth photons are detected as these are incident during the first and third time windows and the SPAD is not in the dead time. The second, third and fifth photons are not detected as these are not incident during the first, second, third or fourth time windows but instead are incident when the SPAD is deactivated.

By introducing the gating time, the SPAD is unable to detect any photons at the end of each symbol. Hence, the probability of the SPAD being inactive at the beginning of the symbol due to the avalanche triggered by photon detection in previous symbol reduced. As a result, dead time induced ISI effects can be mitigated. Note that even with gating operation, the avalanche triggered during one gate-ON time interval might still introduce a dead time that extends to the following gate-ON periods if the dead time is relatively long, which results in residual ISI effects. Employing time-gating SPAD can also effectively reduce the number of background photon counts and hence is beneficial to the communication performance. For instance, as shown in FIG. 5, when the second symbol (bit ‘0’) is transmitted, we expect that the received photon count is as low as possible. However, due to the existence of background light, one photon is detected during this symbol duration if SPAD receiver without gating is employed. In the presence of gating, since the photon arrives during the gate-OFF time interval, it cannot be detected.

Since during the gate-OFF time, the signal photons are also undetectable, introducing gating can result in less detected signal photon counts, which in turn degrades the performance. As presented in FIG. 5, in the absence of time gating, two signal photons can be detected in the first symbol (bit ‘1’); whereas, only one can be detected in the presence of gating. Due to the trade-off of employing time-gated SPAD, for any given system an optimal gate ON-time T_{g}* should exist which will result in the optimal performance.

It will be understood that features of the optical embodiments and the electronic embodiments described above may be combined with features of the described electronic embodiments, in any suitable combination, in further embodiments. As a first non-limiting example, the beam splitter of FIG. 4 may be replaced by the optical switch of FIG. 3, and vice versa.

In the above described embodiment, the electronic selection circuitry 324b or 424b is actively controlled by the controller 316, such that, in a first configuration, photodetector signals are routed from the first set of photodetectors to the demodulation circuitry and in a second configuration, photodetector signals are routed from the second set of photodetectors to the demodulation circuitry. However, it will be understood that, in other embodiments, the electronic selection circuitry is not actively controlled but rather configured to perform a comparison process on the two outputs to determine which set of photodiodes is providing a more reliable signal and then pass that signal to the demodulation circuitry. Such a comparison process is performed between a first measure representative of achievable signal quality and/or signal strength and/or data rate from the SPAD array for the detected light level and a second measure representative of signal quality and/or signal strength and/or data rate detected via the further photodetectors for the detected light level. It will be understood that in such embodiments, the electronic selection circuitry may form part of the controller itself.

Turning now to the control method performed by the controller, the control method controls both the mode of operation of the device and the photon count limiter. As discussed above, the photon count limiter is characterised by a control parameter, which limits the photon count of the photon-counter photodetectors. As discussed in the following, the controller 16 is configured to determine values of the control parameter (the transmittance of the variable optical attenuator (VOA) denoted as a and the gate-ON time interval denoted as T_{g}) during operation. Optimal values can be obtained by minimising a BER function of the communication system, which depends on the underlying modulation scheme. For example, for OOK modulation considered here as an example, the BER equation of the SPAD photodetectors can be estimated as

$${BER}_{SPAD} = Q [ \frac{\sqrt{{N}_{SPAD}} {u}_{1} ( β , {P}_{R} , {P}_{b} , R , {T}_{d} ) - \sqrt{{N}_{SPAD}} {u}_{0} ( β , {P}_{b} , R , {T}_{d} )}{{σ}_{1} ( β , {P}_{R} , {P}_{b} , R , {T}_{d} ) - {σ}_{0} ( β , {P}_{b} , R , {T}_{d} )} ]$$

where β denotes the adaptive parameter (the control parameter) of the photon count limiter and is equivalent to either the transmittance of the variable optical attenuator a or the gate-ON time interval T_{g} for the time gate circuitry. In addition, P_{R} and P_{b} refer to the received signal and background power, respectively, N_{SPAD} is the SPAD array size, R denotes the data rate, and T_{d} is the dead time of SPAD. The received signal and background power are suitable measurements for light level.

The symbols u₁ and u₀ refers to the average detected photon count when bit ‘1’ and bit ‘0’ are sent and σ₁ and σ₀ are corresponding variances. All these moments are functions of the above-mentioned parameters of the adaptive receiver. In general, for a given system, R, T_{d} and N_{SPAD} are known in advance. Therefore, the optimised parameters of the receiver, i.e., α and T_{g}, which minimize the BER function are dependent on two incident power P_{R} and P_{b} which can be estimated periodically.

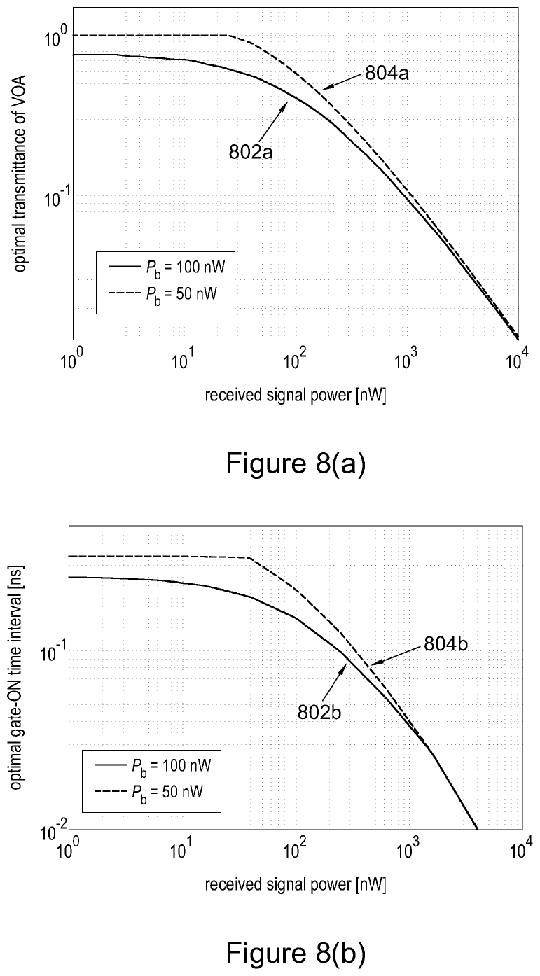

By minimising the BER function, the optimised parameters α* and T_{g}* can be obtained as a function of both P_{R} and P_{b}. The optimal parameters and their dependence on the detected light level (P_{R} and P_{b}) are described with reference to FIGS. 8(a) and 8(b).

While the optimal values for these parameters can be obtained by minimising the above BER equation, it will be understood that these values can also be stored in a look-up table and obtained, during operation, from the look-up table (LT₂(P_{R},P_{b})). The implementation of look-up tables in a control algorithm are described with reference to FIG. 6. The look-up table provides a mapping between a determined signal and background power and the optimal value of the parameter. The look-up tables can be generated offline, based on measurement, for example, or generated as part of a calibration procedure, or via numerical methods, for example, a numerical estimation method. In general, as the mapping between optimal parameters and signal/background will differ between modulation schemes, each modulation scheme will have a respective look-up table (for example, PAM or OFDM).

The control method of the hybrid receiver aims to select the minimal value for BER between LPD and SPAD array through optical switch or otherwise. To implement the switching, the optimal BER value of the SPAD array BER_{SPAD} (obtained using values for selecting α* and T_{g}*) is compared with the BER value of the LPD, BER_{LPD}. When BER_{SPAD}<BER_{LPD}, a control signal should be sent to optical switch to switch the received light to the LPD; otherwise, the light should be guided to the SPAD array.

As a further example, as the switching between detectors are functions of P_{R} and P_{b}, a binary look-up table LT₁(P_{R},P_{b}) representing a mapping between signal/background power values and the first or second mode can be pre-determined and stored on a memory resource of the device. The look-up table can be implemented in use for quickly obtaining the desired mode based on the P_{R} and P_{b}. In a practical implementation, a binary look-up table can be generated offline with zero refers to ‘switching to LPD’ and one refers to ‘switching to SPAD’.

During the communication, for any estimated P_{R} and P_{b}, the switching between modes can be quickly realized by using this look-up table. The use of look-up tables LT1 and LT2 are used in the algorithm described with reference to FIG. 6, where a feedforward control scheme is assumed. In other embodiments, the receiver can also be implemented based on feedback control schemes that iteratively adjust the parameters of the variable photon count limiter to its optimum value. In such schemes, the control signal is generated using mathematical algorithms, for example, gradient descent, to minimize the BER function, rather being read from a look-up table generated in advance.

FIG. 6 illustrates a flowchart outlining a control algorithm 600 for the controller, in accordance with embodiments. While FIG. 6 illustrates an example control algorithm, it will be understood that other control algorithms or variations of the described control algorithm can be made.

At step 602, values of detected background and signal light level are estimated. In the present embodiment, the light level is continuously or periodically estimated by the light level detection circuitry.

At step 604, a determination is made as to whether the signal and background light levels represent a significant change. This step may be implemented simply as a comparison between the newly estimated light levels with the previously recorded light levels (stored on the memory resource, for example). A significant change is a difference between subsequent estimates of greater than a particular threshold value. For outdoor FSO communication, the light level usually changes with the change of the weather condition that with a coherence time on the order of minutes to hours. If it is determined that there is no significant change, then the method returns to step 602. If, at step 604, it is determined that there is a significant change, the method proceeds to step 606.

At step 606, the estimated light level values are used to determine a desired mode of operation of the device between a first mode in which the array of SPADs provide photodetector signals for processing or a second mode in which the array of linear photodetectors provide photodetector signals for processing. In effect, at low irradiance levels, the mode is switched to the first mode to achieve the highest sensitivity levels while it will be switched to the LPD when the irradiance increases beyond a threshold. For example, as shown in FIG. 7(a), with R=3 Gbps and P_{b}=100 nW, the hybrid receiver operates in the first mode when the received signal power is below 60 μW and switches to the second mode when the power is beyond this threshold. Note that in general, this threshold varies with different system parameters, for example, the threshold may vary with data rate and background power.

In the present embodiment, at step 608, the controller uses the look-up table LT₁(P_{R},P_{b}) to obtain the preferred mode of operation for the estimated value of signal and background light levels.

If the desired mode is determined as the first mode (step 608) the method proceeds to step 610. At step 610, an optimal value for the operational parameter of the photon count limiter is obtained. For embodiments with a variable optical attenuator, this operational parameter is the transmittance a. For embodiments with gating circuitry, the operation parameter is the time gating parameter T_{g}. In the present embodiment, the controller uses a look-up table LT₂(P_{R},P_{b}) to obtain the value for the optimal parameter.

At step 612, the controller adjusts the operational parameter of the photon count limiter by sending a control signal to the photon count limiter. At step 614, the controller switches to the first mode of operation if previously in the second mode of operation or remains in the first mode of operation if previously in the first mode of operation. The method then returns to step 602.

If the desired mode is determined as the second mode (step 616) the method proceeds to step 618. At step 618, the controller switches to the second mode of operation if previously in the first mode of operation or remains in the second mode of operation if previously in the second mode of operation. The method then returns to step 602.

It will be understood that certain steps of method 600 may be varied. In a first non-limiting example variation, step 612 may be implemented by a mathematical method, for example, gradient descent, to determine the minimal value for a particular function, in this case the bit error function, described above.

In a further embodiment, the steps of the method 600 occur in a different order. In this embodiment, the desired operational mode (corresponding to step 606) may be performed after determining an optimal value for the operational parameter of the photon count limiter (corresponding to step 614). Such an embodiment is then able to use the determined optimal value for the photon count limiter when determining the desired operational mode. For example, determining the desired operational mode may include comparing an achievable data rate for both modes and selecting the desired mode based on this comparison. This may take into account an optimal value determination, for example, the optimal value for the operation parameter of the photon count limiter may be determine before step 606. At this alternative step 606, a value for the bit error rate for the first mode is estimated using the estimated light levels and using the optimal value for the operational parameter of the photon count limiter. A value for the bit error rate for the second mode is also estimated. These values are then compared to determine the desired mode. In particular, the mode that provides the lower bit error rate value is the desired mode.

Although bit error rate function is described, other functions or parameters representative of performance may be used, for example, achievable data rate, signal quality, signal strength.

FIGS. 7(a) and 7(b) show an example of the performance of the hybrid receiver compared to individual detectors when the transmitted signal is with OOK modulation. FIG. 7(a) illustrates performance in terms of bit error rate at different irradiance levels when the data rate is 3 Gbps and FIG. 7(b) illustrates the achievable data rate. These results are based on embodiments in which the photon count limiter is a variable optical attenuator and embodiments in which the photon count limiter is time gating circuitry. These results also use the control algorithm as described with reference to FIG. 6 (a feedforward control scheme). As can be observed from FIG. 7, the gap in operational range between the SPAD array only (line 702a) and the linear PD array only (line 704a) is bridged by the hybrid receiver (line 706a). FIG. 7(a) also demonstrates that both variable optical attenuation and time gating based devices achieve similar performance. While these results are for on-off keying (OOK) modulation, the receiver can also be applied to systems with higher order modulation schemes, for example, pulse amplitude modulation (PAM) and OFDM.

FIG. 7(b) depicts the achievable data rates for individual (SPAD or LPD) and the hybrid receivers. It can clearly be seen that reliable operation regime of the SPAD array (line 702b) and the linear PD array (line 704b) do not overlap and therefore a simple combination of the two receivers cannot provide a monotonically increasing performance level as the incident light level increases. However, by adaptively switching between the two modes while controlling the light levels using the photon count limiter (line 706b) the hybrid receiver outperforms the original SPAD-based or LPD receivers and may demonstrate a monotonically increasing performance over the whole dynamic range of incident light intensity.

FIG. 8(a) is a graph depicting the optimal values of the operational parameter of the variable optical attenuation (transmittance) a as a function of received signal power P_{R}. Two lines are plotted—a first, lower line 802a for a background power of 100 nW and a second, upper line 804a for a background power of 50 nW.

FIG. 8(b) is a graph depicting the optimal values of the operational parameter of the time gating circuitry T_{g} as a function of received signal power P_{R}. Again, two lines are plotted—a first, upper line 804b for a background power of 100 nW and a second, lower line 802b for a background power of 50 nW.

In the above-described embodiments, optical communication signals are received. It will be understood that the receiving device is suitable for receiving any suitable optical communication signal, for example, optical communication signals transmitted through any suitable medium, for example, free space, water, or particular materials. The device is suitable for wireless and wired optical communication and, for example, receiving signals transmitted via optical fibre. For these different purposes, a suitable optical interface may be provided at the photodetectors. As a non-limiting example, for free-space optical communication an aperture may be provided. As a further non-limiting example, for optical fibre communication, a lens or other focusing optical element may be provided.

The above-described receiver may find a number of applications in different environmental conditions, in particular, environmental conditions that are subject to change in lighting. The receiver may improve the free space optical link under various weather conditions. For example, in adverse weather conditions, the received light power is relatively weak and the receiver will generally operate in the SPAD-mode due to its high sensitivity. However, in clear weather condition, the received optical power is relatively high, the receiver would switch to the linear photodiode mode, since the SPADs will suffers from saturation in such light conditions whereas the PD is with high signal-to-noise ratio (SNR) and can achieve reliable communication.

A skilled person will appreciate that variations of the enclosed arrangement are possible without departing from the invention.

As a first non-limiting example, the light level detection circuitry is replaced by or provided together with monitoring circuitry for monitoring an output of either the one or more photon-counter photodetectors or the one or more further photodetectors for a change in light level. The monitoring circuitry then provides a signal representative of a change in light level to the controller. The controller may perform one or more control operations based on receiving the change in light level. The monitoring circuitry is provided as part of the device or remotely from the device.

As a further non-limiting example, the receiving device has only a single photon-counter photodetector and/or a single further photodetector. In some embodiments, the photon-counter photodetectors comprise one or more photon-counter photodetector devices. In some embodiments, the further photodetectors comprise one or more further photodetector devices.

As a further non-limiting example, decoding and/or demodulation may be performed on photodetector signals from both sets of photodetectors.

As a further non-limiting example, photon-counter photodetectors other than SPADs may be used; in particular, other photon counter detectors that suffer from corresponding problems relating to dead time and saturation may be used. Other further photodetectors may also be used. In principle, the receiving device is an adaptive receiving for combining two types of photodetectors having different operational ranges: a first type of photodetector operable in a low light level and a second type of photodetector operable in a higher light level. In addition, other linear photodetectors may be used. The difference between the types of photodetectors can be classified non-linear/linear: i.e. the non-linear photodetectors (e.g. SPADs) provide a non-linear response to receiving a photon/light while the further linear photodetectors provided a linear response to receiving a photon/light. The difference may also be classified in terms of quantum/classical i.e. the photon-counter photodetectors (e.g. SPADs) operate in a quantum physics regime while the further linear photodetectors operate at a classical level.

While the above-described embodiments describe separate component parts, it will be understood that any two or more of these components may be integrated together or one or more component may form part of another component. For example, the demodulation circuitry or the light detection circuitry or the electronic switching circuitry may be provided as part of the controller. The controller may be a programmable processor or programmable logic resource, for example, a FPGA or a digital signal-processing controller.

As a further non-limiting example, the one or more photodetectors and the one or more further photodetectors may be the same photodetector or provided as part of the same photodetector device or may comprise a common photodetector. In such an example, the same photodetector or photodetector device or common photodetector (herein referred to as simply the common photodetector) may be operable in at least two modes, for example, a non-linear mode in which the common photodetector provide a non-linear (a SPAD-like) response to receiving a photon/light and a linear mode in which the common photodetector provides a linear response to receiving light. In such an embodiment, the operational mode of the common photodetector may be controlled by the controller based on the detected light level (such that common photodetector operates in the non-linear mode in a low light level and in the linear mode in a higher light level). The modes of the common photodetector may correspond to the modes describes with reference to the receiving device, for example, below a certain light level threshold, the common photodetector operates in the non-linear mode to produce the photodetector signals which are demodulated or decoded as described above, while above a certain light level threshold, the common photodetector operates in the linear mode to produce the further photodetector signals which are demodulated or decoded as described above. The photon count limiter may only operate when the detected light is below the threshold. It will be understood that more than one common photodetector may be provided.

In a further non-limiting example, the one or more photodetector and the one or more further photodetectors may comprise at least one common component. The at least one common component may be, for example, a photodiode, a read-out circuit and/or the amplifier.

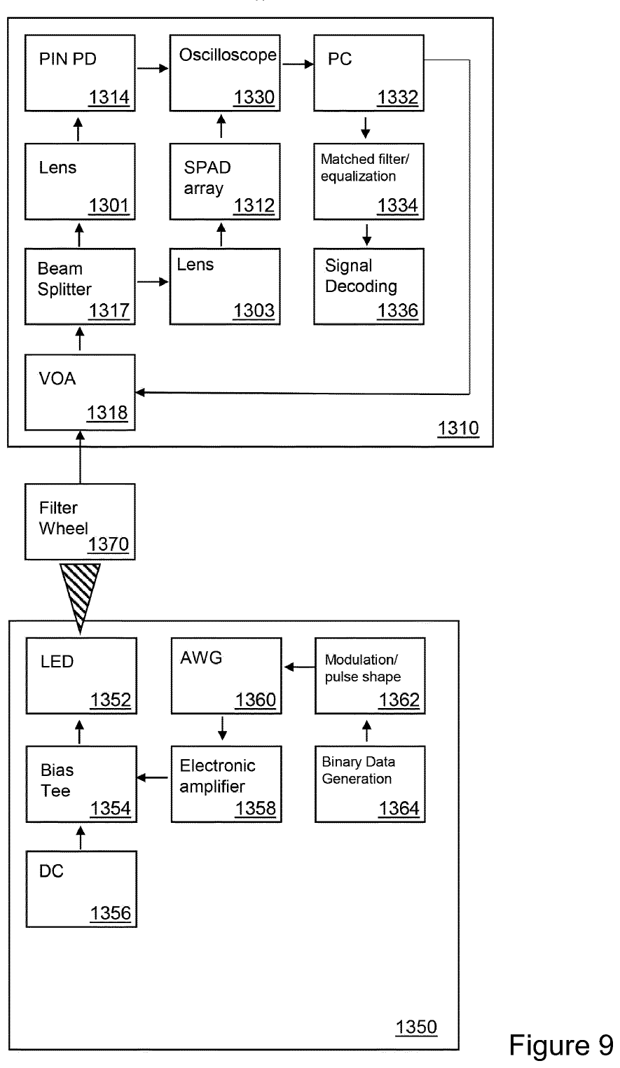

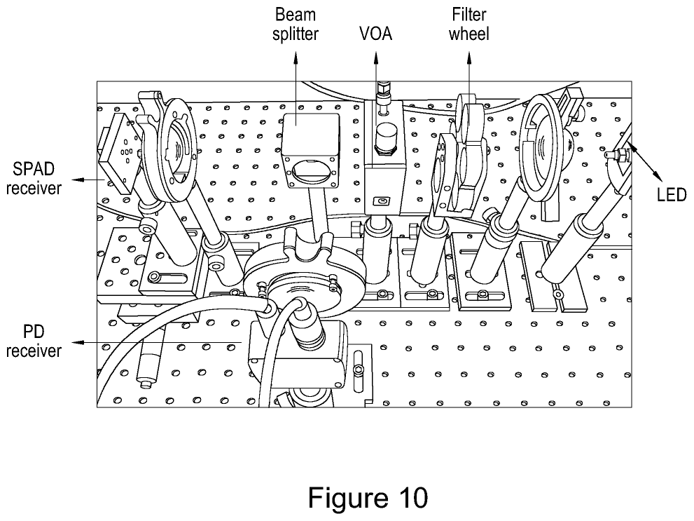

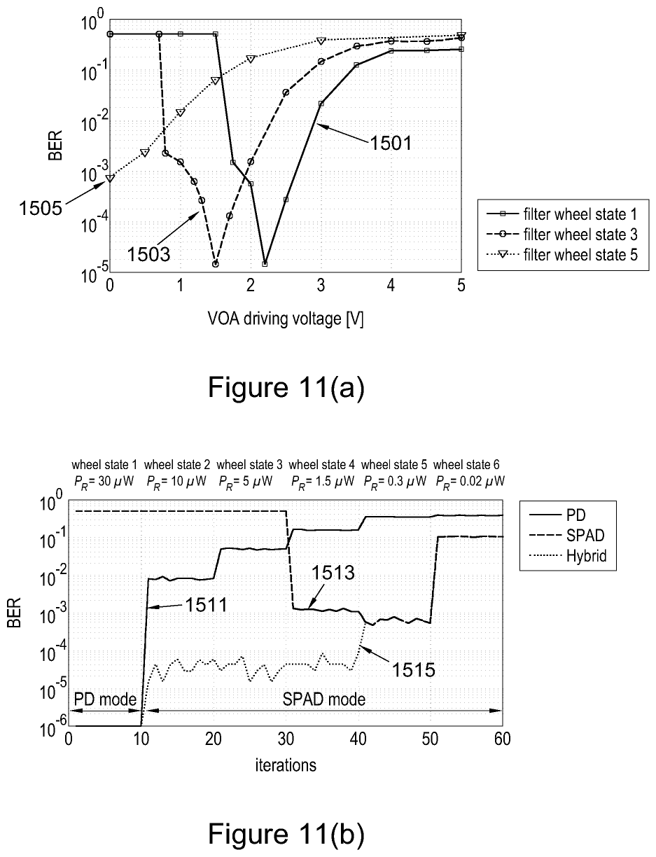

FIG. 9 is a schematic block diagram of an experimental setup for performing experiments using a receiving device 1310 in accordance with an embodiment. As described in the following a transmitter 1350 and filter wheel 1370 are also provided for performing the experiments. FIG. 10 is a photograph of the experimental setup, described with reference to FIG. 9. FIGS. 11(a) and (b) depict results from the experiment demonstration. It will be understood that the experiments are performed in dark conditions to minimize background light level.

The receiving device 1310 of FIG. 9 closely corresponds to the receiving device 310 described with reference to FIG. 3. As a high-speed optical switch was not available for the experiments, a 50:50 beam splitter is used in place of the optical switch.

The receiving device has a VOA 1318, a PIN photodiode 1314 and a SPAD array detector 1312. The PIN photodiode 1314 has a corresponding lens 1301 for focusing incident light on to the PIN photodiode. The SPAD array 1312 also has a corresponding lens 1303 for focusing incident light on to the SPAD array 1312. The receiving device 1310 also has an oscilloscope 1330 and processing circuitry (in this embodiment provided on a personal computer, PC, 1332). The processing circuitry runs software (MATLAB) to perform matched filter, equalisation and signal decoding (represented by blocks 1334 and 1336, respectively). In this embodiment, the PC 1332 may be considered as performing the role of the controller (as described with reference to controller 316 of FIG. 3) and is responsible for determining the operational mode and adjusting the VOA 1318.

The VOA 1318 (Thorlabs LCC1620) used in this setup can change its transmittance through the applied driving voltage. With the increase of the driving voltage, the normalized transmittance can decrease from 100% to only 0.15%.

A further difference between the receiving device described with reference to FIG. 3 and the receiving device 1310 regards the placement of the VOA relative to the beam splitter/optical switch. In contrast to receiving device 310 where the VOA is placed in front of the SPAD array, in this setup, the VOA is placed in front of the beam splitter. The reason for this change is that the VOA is liquid-crystal-based which can introduce around 4.5 dB fixed power loss to the input LED light even when the driving voltage is zero. Therefore, putting the VOA in front of the SPAD receiver will lead to a difference in received optical power for the two receivers. It has been found that, in the setup, this difference may be reduced by moving the VOA to the position in front of the beam splitter. While, in this embodiment, the VOA is provided in front of both the PIN PD and the SPAD array, it will be understood that the VOA is only in operation when the receiver works in SPAD mode.

Turning to the transmitting device 1350 (also referred to as the transmitter for brevity) that is used in the experiments, the transmitter 1350 has an LED 1352 for emitting light. The transmitting device 1350 also has a bias tee 1354, a direct current power supply 1356, an electronic amplifier 1358 and an arbitrary waveform generator AWG 1360. The transmitter 1350 is also connected to a processing resource (in this experiment provided by the PC). The PC runs software (MATLAB) to perform binary data generation and modulation/pulse shaping steps, represented by blocks 1362 and 1364. While these steps are performed by the processing resource of a PC for these experiments, it will be understood that these functions could be performed using a signal processing/modulation circuitry provided on the transmitting device.

Between the transmitter 1350 and the receiver 1310, a filter wheel 1370 is provided for controlling the experimental conditions. The filter wheel 1370 is provided to emulate the optical power fluctuation introduced by practical OWC channels. The filter wheel 1370 (Thorlabs FW1A) holds several neutral density (ND) filters. These ND filters can provide six different optical transmittance states, for example: 100%, 32%, 16%, 5%, 1% and 0.07% for the light being transmitted between the transmitter and the receiver. The transmittance state can be changed by manually rotating the filter wheel. By manually rotate the wheel, various received signal power at the receiver can be realized.

In operation, at the transmitter side, a binary data stream is generated (block 1364) and after applying the modulation and pulse shaping using MATLAB (block 1362), the modulated signal is sent to an arbitrary waveform generator 1360 (AWG, Keysight 81180A). The output signal of the AWG 1360 is amplified by the electronic amplifier 1358 (Mini-Circuits ZHL-6AS+). The amplified signal is then combined with a DC bias from a DC power supply 1356 by using a Bias-Tee (Mini-Circuits ZFBT-4R2GVV). The output of the Bias-Tee is used to drive the LED light source 1352 which has a central wavelength of 525 nm. In this demonstration, a 450 Mbps OOK signal transmission is considered.

In operation, at the receiver side, the two split optical beams are received by the PIN PD 1314 and the SPAD array 1312, respectively. Note that as the proposed receiver is a hard switching receiver, utilizing a beam splitter rather than ideal optical switch can introduce an additional 3 dB power loss. The PIN PD 1314 (Thorlabs PDA10A2) in the system has a 3-dB bandwidth of 150 MHz and a responsivity of 0.25 A/W at 525 nm. The employed SPAD array 1312 (Hamamatsu C11209-110) comprises 10,000 SPAD pixels and is with a PDE of 10% at 525 nm, a fill factor of 33%, and a dead time of around 31 ns. PDE refers to photon detection efficiency which is the probability of detecting an incoming photon and is a measure of the sensitivity of a SPAD. Lens 1301 and lens 1303 are two aspheric condenser lenses and these focus the light into the active area of the PIN PD 1314 and the SPAD array 1312. Note that since the PIN PD 1314 and the SPAD array 1312 have slightly different active area, the optical alignment is carefully adjusted to ensure that the optical power incident to the detectors are approximately the same.

The signal outputs of both the PIN PD 1314 and the SPAD array 1312 are fed into the oscilloscope 1330 (Keysight DSO7104A) and sent to the PC 1332. The matched filter, equalization and signal decoding steps are then applied using MATLAB. For each transmittance state of the filter wheel 1370, the BER of the PD is measured. On the other hand, for the SPAD array 1312, the optimal transmittance of the VOA which leads to the lowest BER is also determined. In this demonstration, optimal transmittance (or equivalently the optimal VOA driving voltage) is achieved through an exhaustive search. In practice this could be determined prior to communication.

FIG. 11(a) presents the measured BER of the SPAD array 1312 against the VOA driving voltage for different wheel states. It is shown that with different filter wheel states, the optimal VOA driving voltage varies, as expected. Filter wheel state 1 is represented by line 1501; filter wheel state 3 is represented by line 1503; filter wheel state 5 is represented by line 1505 (other filter wheel states are not depicted). It is observed that the optimal voltage for the wheel state 1 (transmittance 100%), state 3 (transmittance 16%) and state 5 (transmittance 1%) are 2.2 V, 1.5 V, and 0 V, respectively. Note that in this result, the increase of the BER with the increase of the optical power (or equivalently the decrease of the VOA driving voltage) is mainly due to the dead-time-induced ISI (inter-symbol interference) effects. The measured optimal SPAD BER is compared with the corresponding BER of the PIN PD. If the former is less than the latter, the receiver should operate in the SPAD mode; otherwise, it should operate in the linear photodetector mode.

TABLE 1
TABLE I
SAVED LOOK-UP TABLE

| | Channel Transmittance | | VOA Voltage |
|---|---|---|---|
| Wheel State | [%] | Receiver Mode | [V] |
| 1 | 100 | PD | 0 |
| 2 | 32 | SPAD | 1.8 |
| 3 | 16 | SPAD | 1.5 |
| 4 | 5 | SPAD | 0.9 |
| 5 | 1 | SPAD | 0 |
| 6 | 0.07 | SPAD | 0 |

The measured hybrid receiver operation mode and the optimal VOA driving voltage under different filter wheel states are summarized in Table I. It is shown that, when the filter wheel is with 100% transmittance, the received optical power is relatively high and the hybrid receiver should operate in linear photodetector mode in which the output of the PIN PD 1314 is used for decoding (and the VOA has zero driving voltage and is therefore, in effect, not operating). When the optical power is attenuated, the hybrid receiver should in turn operate in SPAD mode in which the output of the SPAD array 1312 is used for decoding. With lower filter wheel transmittance, the VOA should attenuate the optical power incident to the SPAD array less through the decrease of the VOA driving voltage to ensure the optimal performance of SPAD array. When the filter wheel transmittance is extremely low, e.g., for wheel state 5 and 6, the SPAD array 1312 becomes signal power limited and the optimal VOA driving voltage becomes zero. This lookup table is generated offline and is saved at the PC.

Note that in our setup, the PC acts as the hybrid receiver controller which is responsible for determining the operational mode and adjusting the VOA. When the receiver is in operation, as long as the received signal power changes through the rotation of the filter wheel, the receiver operational mode and the optimal VOA driving voltage can be determined from the table. The controller then sends the voltage signal to the VOA and uses the correct detector output for decoding.

FIG. 11(b) demonstrates the measured BER under different filter wheel states. For each filter wheel states, ten iterations have been conducted. The measured received signal power under various channel attenuation is also presented in the figure. The performance of the proposed hybrid receiver was measured together with the performance of the individual PD receiver and SPAD receiver. The BER of the PD receiver is represented by line 1511, the BER of the SPAD receiver by line 1513 and the BER of the hybrid receiver by line 1515.

It is will be understood that for the employed commercial SPAD receiver, when P_{R} (received average optical power) is above 5 μW, its output cannot be obtained due to its built-in over-current protection triggered by the excessive light incident, which renders a measured BER of 0.5. With the decrease of P_{R}, the decrease and then increase of the SPAD receiver BER can be observed. On the other hand, for the PD receiver, the decrease of P_{R} always results in worse BER performance, as expected.

Turning to the performance of the hybrid receiver, it is shown that when operated in PD mode, i.e., P_{R}=30 μW, the BER of the hybrid receiver is the same as that of the PD receiver. When the received signal power is strongly attenuated, i.e., P_{R}=0.3 μW and P_{R}=0.02 μW, it is identical to that of the SPAD receiver. However, it is clear from the results that the proposed hybrid receiver significantly outperforms its counterparts in the intermediate received signal power regime. For instance, when P_{R}=1.5 μW, the BERs of the PD receiver and the SPAD receiver are 0.15 and 10⁻³, respectively, but the corresponding BER for hybrid receiver is only 4×10⁻⁵. Therefore, it is demonstrated that the hybrid receiver can effectively extend the range of the operational incident optical power.

Accordingly, the above description of the specific embodiment is made by way of example only and not for the purposes of limitations. It will be clear to the skilled person that minor modifications may be made without significant changes to the operation described

1. A receiving device for receiving an optical communication signal, wherein the optical communication signal comprises an encoded or modulated signal, the device comprising:
one or more photodetectors configured to produce photodetector signals in response to detecting photons;
one or more further photodetectors configured to produce further photodetector signals;
a controller configured to select an operational mode of the receiving device in dependence on at least a light level, wherein the operational mode is one of at least a first mode in which a demodulation or decoding process is performed on the photodetector signals and a second mode in which the demodulation or decoding process is performed on the further photodetector signals, and
a photon count limiter associated with the one or more photodetectors for controlled limiting of the photon count of the one or more photodetectors in dependence on at least a light level.

2. The device as claimed in claim 1, wherein the one or more further photodetectors comprise one or more linear photodetectors and/or wherein the one or more photodetectors comprises one more photon-counting photodetectors, for example, single-photon avalanche diodes (SPADs).

3. The device as claimed in claim 1, wherein the controller is configured to control the operational mode of the device and/or to control the photon count limiter to target at least one of: a maximum value of a measure of signal quality and/or signal strength and/or achievable data rate and/or a minimum measure of error rate.

4. The device as claimed in claim 1, wherein the photon count limiter is controllable to limit the photon count of the one or more photodetectors below a variable upper threshold value.

5. The device as claimed in claim 1, wherein control of the photon detection limiter to limit the number of photodetector events detected by the one or more photodetectors comprises selecting or adjusting a value for a control parameter for the photon detection limiter.

6. The device as claimed in claim 1, wherein the photon count limiter comprises a variable optical attenuation device arranged to attenuate light for the one or more photodetectors, wherein the degree of attenuation of light is controlled by selecting and/or adjusting a control parameter of the variable optical attenuation device.

7. The device as claimed in claim 1, wherein the photon count limiter comprises time gating circuitry associated with the one or more photodetectors configured to perform a gating process thereby to limit the number of photodetector signals produced by the one or more photodetectors.

8. The device as claimed in claim 7, wherein the time gating process is characterized by a time window such that at least one of:
a) photodetector signals are produced only in response to photons incident on the one or more photodetectors during the time window;
b) the one or more photodetectors are activated during the time window and deactivated otherwise.

9. The device as claimed in claim 8, wherein the controller is configured to adjust or select a control parameter of the time gating circuitry thereby to change the size of the time window in response to at least a change in the light level.

10. The device as claimed in claim 8, wherein the gating circuitry is configured to perform a gating process such that the number of photons counted during the time window is fewer than the number of detectable photons incident on the one or more photodetectors during a symbol duration.

11. The device as claimed in claim 1, wherein the device comprises at least one controllable switching component controllable by the controller, the at least one controllable switching component being controllable to be in at least one of a first configuration and a second configuration, such that the controller places the at least one controllable switching component in the first configuration when the device is in the first mode and in the second configuration when the device is in the second mode.

12. The device as claimed in claim 11, wherein the at least one controllable switching component comprises an optical switching apparatus, wherein light is incident on the optical switching apparatus and, in the first configuration, the optical switching apparatus provides at least part of the received light to the one or more photodetectors and, in the second configuration, the optical switching apparatus provides at least part of the received light is provided to the one or more further photodetectors.

13. The device as in claim 12, wherein at least one of:
a) the optical switching component comprises one or more optical switching components configured to re-direct, permit transmission and/or prevent transmission of received light thereby to change an optical path of the received light; or
b) the photon count limiter forms part of the optical switching apparatus such that the optical switching apparatus is controllable to receive light and to direct a controlled portion of received light to either the one or more photodetectors or the further photodetectors in dependence on a control parameter.

14. (canceled)

15. The device as claimed in claim 11, wherein at least one of:
a) the at least one controllable switching component comprises signal routing circuitry such that, in the first configuration, the signal routing circuitry routes signals from the one or more photodetectors for the demodulation or decoding process and, in the second configuration, the signal routing circuitry routes signals from the one or more further photodetectors for the demodulation or decoding process; or
b) the at least one controllable switching component comprises at least one electromechanical component that is moveable or orientable via an electronic control signal provided by the controller.

16. (canceled)

17. The device as claimed in claim 1 wherein at least one of:
a) the device further comprises one or more optical steering components for steering received light to the one or more photodetectors and/or the one or more further photodetectors, optionally wherein the one or more steering components comprise at least one of: an optical splitter, a lens, an aperture, an optical microelectromechanical system (MEMS); or
b) the photon count limiter comprises at least one electromechanical component that is moveable or orientable via an electronic control signal provided by the controller.

18. (canceled)

19. The device as claimed in claim 1, wherein the controller comprises processing circuitry configured to obtain a value for a control parameter for the controllable photon limiter based on a pre-determined relationship between the control parameter and at least the light level, wherein the pre-determined relationship is in dependence on a modulation or coding scheme, optionally, wherein the device further comprises a memory resource for storing a mapping between a plurality of values of the control parameter and a plurality of ranges of light level, and wherein obtaining the value for the control parameter comprises retrieving a stored value from the memory resource using the light level and the mapping.

20. (canceled)

21. The device as claimed in claim 1, wherein at least one of:
a) the controller is further configured to perform a comparison process between a first measure representative of achievable signal quality and/or signal strength and/or data rate from the one or more photodetectors for the light level and a second measure representative of signal quality and/or signal strength and/or data rate detected via the one or more further photodetectors for the light level and further configured to select the operational mode and/or the photon detection limiter based on said comparison process;
b) the modulation and/or coding scheme comprises an intensity modulation scheme, for example, an on-off keying based modulation scheme, an optical OFDM based scheme, PAM or PPM; or
c) further comprises light level detection circuitry configured to receive output from at least one of the one or more photodetectors and the one or more linear photodetector and determine the light level using the received output of the one or more photodetectors and/or the one or more further photodetectors.

22. (canceled)

23. (canceled)

24. The device as claimed in claim 1, wherein at least one of:
a) the one or more photodetector and the one or more further photodetector comprise at least one common photodetector operable to produce the photodetector signals and the further photodetector signals; or
b) the one or more photodetector and the one or more further photodetector comprises at least one common component.

25. (canceled)

26. A method of receiving an optical communication signal using a receiving device operable in at least a first or second mode, the method comprising:
selecting an operational mode for the receiving device based on at least a light level, and in response to selecting the first mode:
receiving light at one or more photodetectors and producing photodetector signals;
limiting the received photon count of the one or more photodetectors in dependence on the light level; and
performing a demodulating or decoding process on the photodetector signals in accordance with a pre-determined modulation or coding scheme thereby to extract data; and
in response to selecting the second mode:
receiving light at one or more further photodetectors and producing further photodetector signals and performing demodulation or decoding process on the further photodetector signals in accordance with the pre-determined modulation or coding scheme thereby to extract data.

27. (canceled)

28. A receiving device for receiving an optical communication signal, wherein the optical communication signal comprises an encoded or modulated signal, the device comprising:
one or more photodetectors operable in at least a first mode or a second mode, wherein in the first mode, the one or more photodetectors are configured to produce photodetector signals in response to detecting photons and wherein in the second mode the one or more photodetectors are configured to produce further photodetector signals;
a controller configured to select an operational mode of one or more photodetectors and an operational mode of the receiving device in dependence on at least a light level, wherein the operational mode is one of at least a first mode in which a demodulation or decoding process is performed on the photodetector signals and a second mode in which the demodulation or decoding process is performed on the further photodetector signals, and
a photon count limiter associated with the one or more photodetector for controlled limiting of the photon count of the one or more photodetectors in dependence on at least a light level.
